(19) United States
(12) Patent Application Publication
(10) Pub. No.: US 2025/0213410 A1
(43) Pub. Date: Jul. 3, 2025

(54) SYSTEMS AND METHODS FOR A HEATING AN INFANT CARE STATION

(71) Applicant: GE Precision Healthcare LLC, Waukesha, WI (US)

(72) Inventors: Nagapriya Kavoori Sethumadhavan, Bangalore (IN); Rajendra Naik, Bangalore (IN)

(21) Appl. No.: 18/400,955

(22) Filed: Dec. 29, 2023

(51) Int. Cl. A61G 11/00

(52) U.S. Cl. CPC A61G 11/00

(57) ABSTRACT

An infant care station is described herein that can include a heater element to generate radiant heat, a first reflective dish, and a second reflective dish positioned higher than a support platform of the infant care station, wherein the first reflective dish and the second reflective dish transfer the radiant heat to the support platform, the first reflective dish to focus and project the radiant heat on the second reflective dish.

### FIELD

Techniques disclosed herein relate to an infant care station, and more particularly to heating an infant care station with a configurable heater.

### BACKGROUND

Some infant patients are not physiologically well enough developed to be able to survive without special medical attention. A frequently used medical aid for such infants is the incubator. The primary objective of the incubator is to provide an environment which will maintain the infant at a minimum metabolic state thereby permitting as rapid physiological development as possible. Neonatal incubators create a microenvironment that is thermally neutral where an infant can develop. These incubators typically include a humidifier and a heater and associated control system that controls the humidity and temperature in the neonatal microenvironment. The humidifier comprises a device that evaporates an evaporant, such as distilled water, to increase relative humidity of air within the neonatal microenvironment. The humidifier is typically controllable such that the amount of water, or water vapor, added to the microenvironment is adjustable in order to control the humidity to a desired value. The heater may be, for example, an air heater controllable to maintain the microenvironment area to a certain temperature. In some examples, radiant warmers may be used instead of incubators for some infants where less environmental control is required. In still other embodiments, hybrid incubator/radiant warming systems may be utilized.

Since the microenvironment is accurately controlled in a neonatal or infant care station, the infant care station includes an enclosure that is sealed to help maintain the controlled microenvironment. Such an enclosure, also called the infant compartment, will typically include four sidewalls or side panels and a top hood or canopy that surround an infant support platform.

Infant care stations can use any number of heaters to provide warm air to an infant residing on an infant support platform such as a mattress or a support platform of the infant care station. In some examples described herein, an infant care station can include at least one configurable heater that can utilize a set of focal points from a reflective dish to provide radiant heat to an infant care station from one or more directions.

### BRIEF DESCRIPTION

This section is provided to introduce a selection of concepts that are further described below in the Detailed Description. This Brief Description is not intended to identify key or essential features of the claimed subject matter, nor is it intended to be used as an aid in limiting the scope of the claimed subject matter.

In one example, an infant care station can include a heater element and a first reflective dish configured to generate radiant heat and a second reflective dish positioned higher than a support platform of the infant care station, wherein the first reflective dish and the second reflective dish transfer the radiant heat to the support platform, the first reflective dish to project the radiant heat onto the second reflective dish.

In some examples, a method for operating an infant care station can include detecting a warmer setting for the infant care station and determining a location of a configurable heater relative to an overhead reflective dish. The method can also include adjusting a power level of a heater element of the configurable heater based on the location of the configurable heater. The power level can control an amount of radiant heat projected from the configurable heater to the overhead reflective dish. The method can also include providing radiant heat to a support platform of the infant care station.

In other examples, a non-transitory computer-readable medium for operating an infant care station can include a plurality of instructions that, in response to execution by a process, cause the processor to detect a reconfiguration of the infant care station and modify an overhead reflective dish in response to the reconfiguration of the infant care station. The plurality of instructions can also cause the processor to provide radiant heat to a support platform using a configurable heater and a modified overhead reflective dish.

Various other features, objects, and advantages of the invention will be made apparent from the following description taken together with the drawings.

### BRIEF DESCRIPTION OF THE DRAWINGS

The present disclosure will be better understood from reading the following description of non-limiting examples, with reference to the attached drawings broadly described below:

FIG. 1 is a perspective view of an example infant care station operating as an infant warmer with a fixed heater;

FIG. 2A is a perspective view of an example infant care station operating as an infant warmer with a configurable heater according to examples herein;

FIG. 2B depicts an example implementation of the configurable heater of an infant care station according to examples herein;

FIG. 3 is a perspective view of an example infant care station operating as an infant warmer with a heater according to examples herein;

FIG. 4 is an example process flow diagram for operating an infant care station with a configurable heater according to examples herein;

FIG. 5 is a perspective view of an example infant care station operating as an infant incubator with a fixed heater;

FIG. 6 is a perspective view of an example infant care station operating as an infant incubator with a configurable heater according to examples herein;

FIG. 7 is a perspective view of an example infant care station operating as an infant incubator with a configurable heater according to examples herein;

FIG. 8 is a perspective view of an example infant care station operating as an infant incubator with a configurable heater according to examples herein;

FIG. 9 is an example process flow diagram for operating an infant care station with a configurable heater according to examples herein;

FIG. 10 illustrates an example computing device for warming an infant care station with a configurable heater in accordance with one example; and

FIG. 11 illustrates computer-readable storage media that can operate an infant care station with a configurable heater.

The drawings illustrate specific aspects of the described components, systems and methods for providing a neonatal infant care system. Together with the following description, the drawings demonstrate and explain the principles of the structures, methods, and principles described herein. In the drawings, the thickness and size of components may be exaggerated or otherwise modified for clarity. Well-known structures, materials, or operations are not shown or described detail to avoid obscuring aspects of the described components, systems and methods.

### DETAILED DESCRIPTION

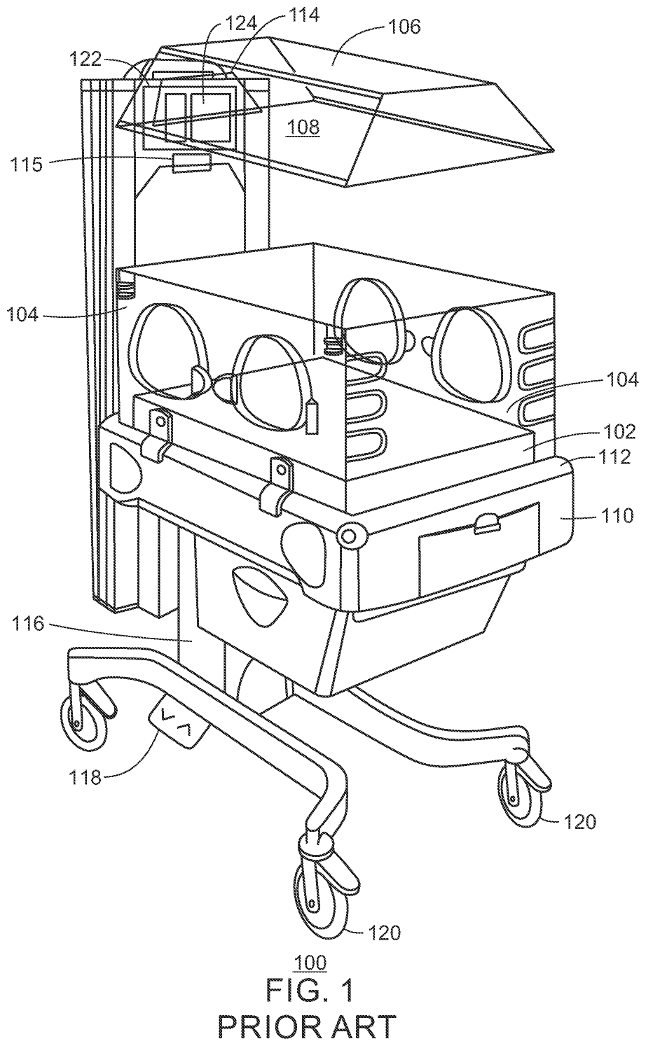

Embodiments of the present disclosure will now be described, by way of example, with reference to FIGS. 1-11, in which the following description relates to various examples of infant care stations. The following description relates to various techniques, methods, non-transitory computer-readable media, and systems for heating an infant care station with one or more configurable heaters. Infant care stations can provide microenvironments for infant patients receiving medical care. Infant care stations, as referred to herein, can include incubators, warmers, or devices that support one or more features of incubators and warmers.

In some infant care stations, multiple heaters can be used to provide radiant warming and convective heating to an infant patient. For example, a first heater can be located in a static location for providing thermally conditioned air to an infant care station using convective heating techniques for an incubator. In other examples, a second heater can be located at a different static location for providing radiant heat to an infant care station using radiant heating techniques for an infant warming station.

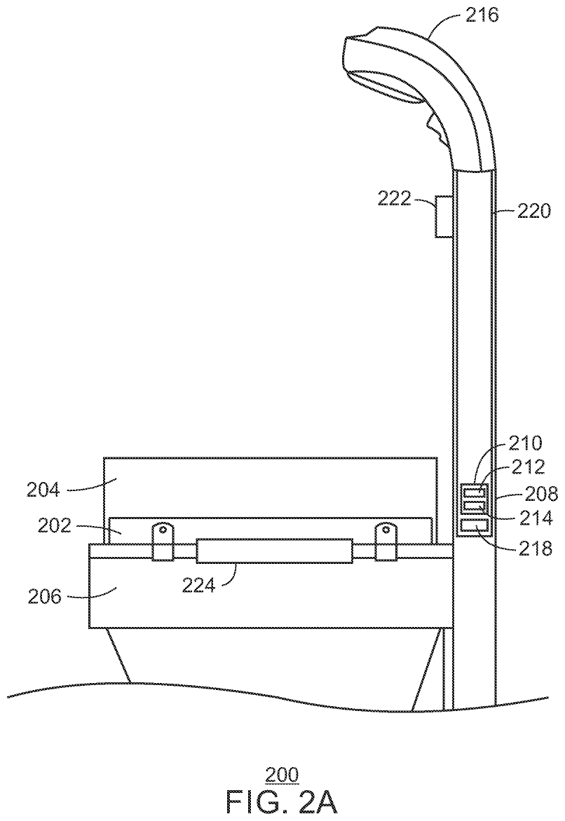

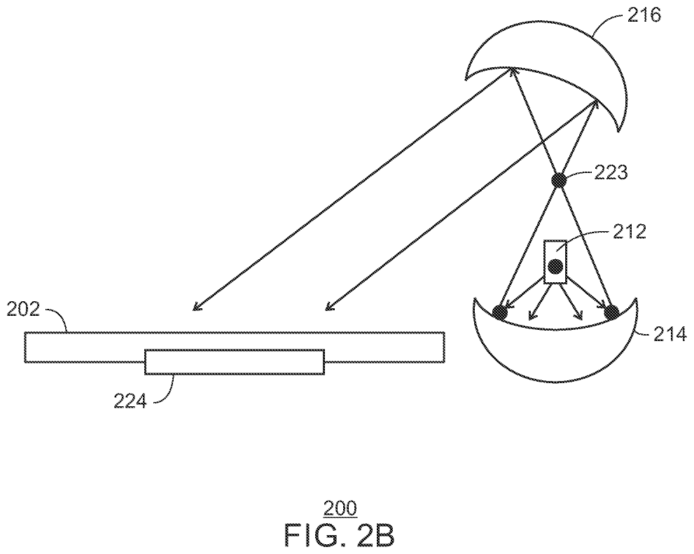

Techniques herein have the technical advantage of using a configurable heater in some examples for providing radiant heat or heat to an infant patient. The configurable heater can be implemented with any number of focal points that can focus, transfer, project, or otherwise provide radiant heat directly to a support platform of an infant care station or indirectly to a support platform of an infant care station using any number of additional reflective surfaces, reflective dishes, or the like. In some examples, the configurable heater can also be repositioned in an infant care station by moving the configurable heater vertically, horizontally, or a combination thereof. In some examples, the configurable heater can rotate, swivel, or otherwise move from a first configuration providing convective heating to an infant care station to a second configuration providing radiant heating to an infant care station. A technical effect or advantage of using a configurable heater to operate an infant care station can include avoiding a pre-warming of the heater and reducing cycling of the multiple heaters of previous infant care stations, which can degrade the heaters. The techniques herein that utilize a configurable heater to provide radiant heating and convective heating can also enable a modification to the infant care station to place the heater in various locations that are removed from the infant patient. For example, the configurable heater can be located behind a housing along a perimeter of a support platform of an infant care station, which can enable additional technical advantages as described in greater detail below in relation to FIGS. 2, 3, 4, and 6-11. In some examples, the configurable heater described herein can enable an infant care station to provide radiant heat to any suitable region or area of a support platform.

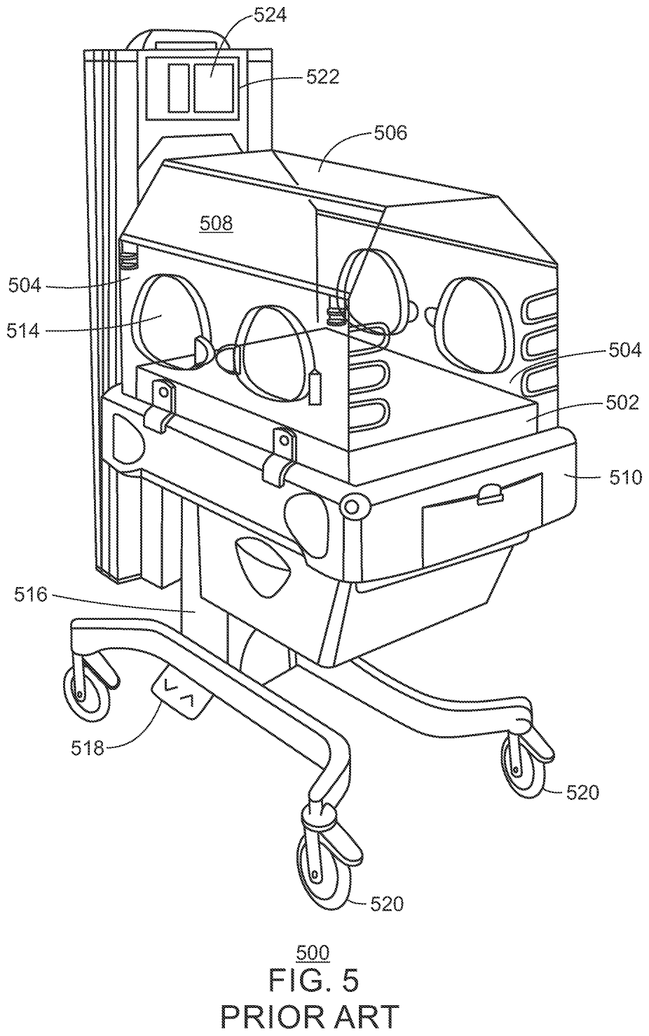

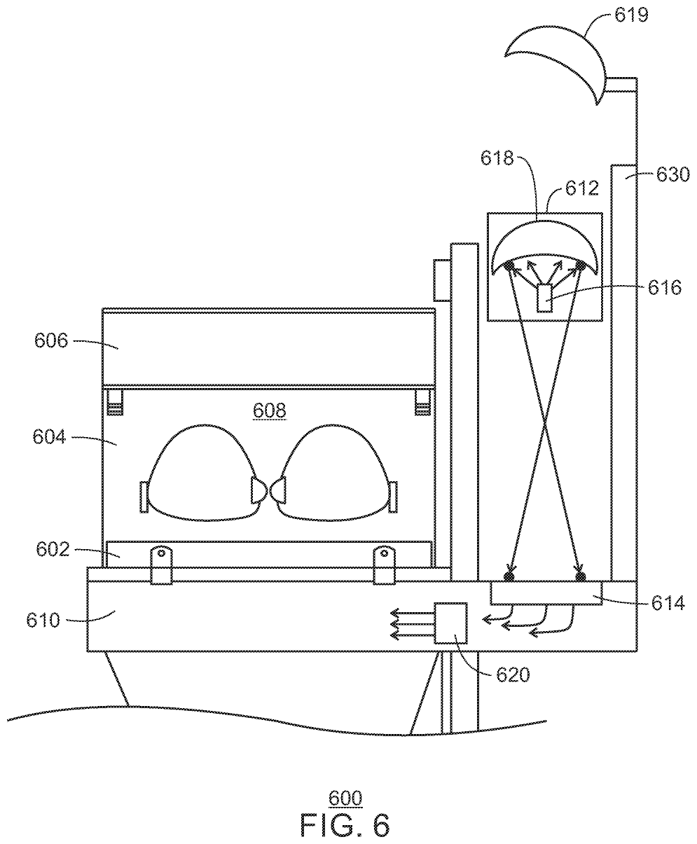

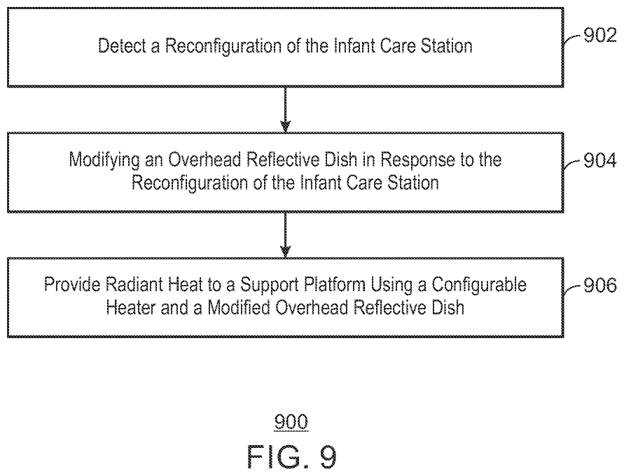

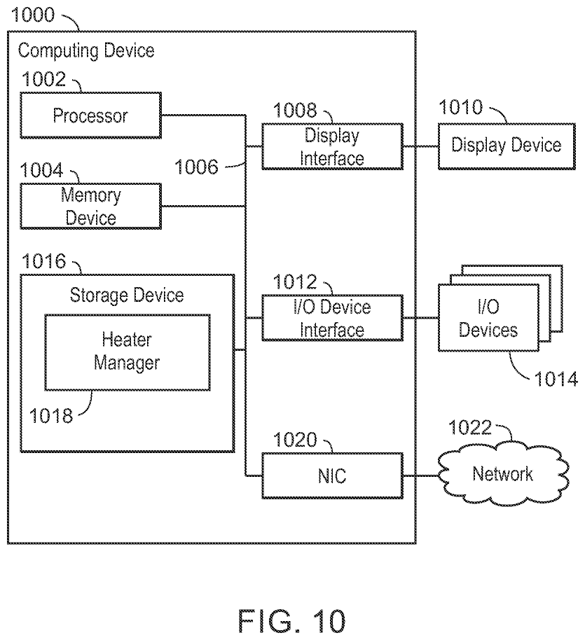

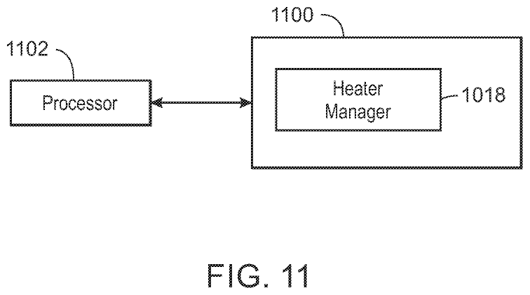

FIG. 1 provides an example embodiment of a previous infant care station configured to operate as an infant warmer using fixed heaters. FIGS. 2A, 2B, 3, and 4 provide example infant care stations operating as an infant warmer with a configurable heater. FIG. 5 provides an example embodiments of a previous infant care station configured to operate with a fixed heater. FIGS. 6, 7, and 8 provide example infant care stations operating as an infant incubator with a configurable heater. FIG. 9 provides an example process flow diagram for operating an infant care station with a configurable heater. FIG. 10 illustrates an example computing device for warming an infant care station with a configurable heater. FIG. 11 provides a computer-readable storage media that can operate an infant care station with a configurable heater.

FIG. 1 is a perspective view of an example infant care station operating as an infant warmer with a fixed heater. In some examples, the infant care station 100 can include a horizontal surface 102, walls 104, and canopy 106 being connected. In some examples, the horizontal surface 102, walls 104, and canopy 106 may be individual components that also may be moveable with respect to each other. For example, the example configuration of FIG. 1 depicts an open canopy 106 raised away from the walls 104 to allow operation as a warmer in which the microenvironment is exposed to the surrounding environment of the infant care station 100.

The horizontal surface 102, walls 104, and canopy 106 can define a microenvironment 108 that is exposed to ambient air due to the raised canopy 106. In some examples, the walls 104 further include arm portholes 114 that permit a clinician access into the microenvironment 108. In some examples, the walls 104 can be shorter or taller and may not include arm portholes 114 in a warmer configuration.

In some examples, the infant care station 100 includes a base 110 that supports a support platform 112. The infant care station 100 can also include a radiant heater 114 above the support platform 112. The radiant heater 114 can be configured to provide radiant heat to the support platform 112 to warm an infant patient. As discussed in greater detail below in relation to FIGS. 2-4 and 6-11, techniques herein include placing the radiant heater 114 in a different configuration so that the radiant heater 114 is not above the support platform 112. Moving the location of the radiant heater 114 so that the radiant heater 114 is not above the support platform provides various advantages including, eliminating the dangers of the possibility of hot particles, items (such as screws), etc. falling on the infant (due to removal of heater assemblies and hot items from above the infant); providing heat where it is needed (instead of all over the bed)-based on position and size of infant, thereby increasing efficiency; ability to use a single heater to provide both convective heating (used in general for incubators) and radiant heating (used generally for infant warmers). The radiant heater 114 in FIG. 1 is a dedicated heater for providing radiant heating without the ability to modulate or provide convective heating. In some examples, the infant care station 100 may include a separate second heater (not depicted) to provide thermally conditioned air in an incubator setting with a closed canopy 106.

Examples of the infant care station 100 further include a pedestal 116 connected to the base 110. The pedestal 116 includes mechanical components (not depicted), which may include, but are not limited to, servo motors, rack and pinion systems, or screw gear mechanisms that are operable by foot pedals 118 to raise or lower the base 110, effectively raising or lowering the position of the infant patient (not depicted) in relation to the clinician. The infant care station 100 may be moveable by wheels or casters 120 connected to the pedestal 116.

The example of the infant care station 100 depicted in FIG. 1 includes a graphical display 122 that is mounted to a wall, the base 110, or the canopy 106 of the infant care station 100 at a position external to the microenvironment 108. The graphical display 122 is operated by a processor to present a graphical user interface (GUI) 124. In the example illustrated, the graphical display 122 is a touch-sensitive graphical display and the GUI 124 is configured to specifically respond to inputs made by a clinician received through the touch-sensitive graphical display. During normal operation, the touch-sensitive graphical display 122 and touch-sensitive configured GUI 124 are used to control various functions of the infant care station 100. The GUI 124 presents a variety of information, such as the air temperature and alarm indications. In some examples, the alarm indications can provide a message indicating a change in environment characteristics, or a warning that an infant patient is too warm, among others.

FIG. 2A is an example infant care station using a configurable heater to provide radiant heat in an infant warmer setting in accordance with one example. In some examples, the infant care station 200 can include a horizontal surface 202 and walls 204. In some examples, the support platform or horizontal surface 202 and walls 204 may be individual components that also may be moveable with respect to each other. For example, the example configuration of FIG. 2A depicts an open microenvironment without a canopy above the walls 204 to allow operation as an infant warmer in which the microenvironment is exposed to the surrounding ambient air and environment of the infant care station 200.

In some examples, the infant care station 200 includes a base 206 that supports a horizontal surface or support platform 202. The infant care station 200 can also include a housing 208 that can include any number of components such as a configurable heater 210 proximate to the support platform 202. The configurable heater 210 can be configured to provide radiant heat to the support platform 202 in a uniform manner to warm an infant patient. For example, the configurable heater 210 can include a heater element 212 and a first reflective dish 214 that can be configured to provide radiant heat upward to a second overhead reflective dish 216. The reflective dish 216 can enable radiant heat to be provided to an infant patient on the horizontal surface 202. In some examples, the configurable heater 210 provides radiant heat to the reflective dish 216 or any suitable reflective surface to enable a radiant heating setting for the infant care station 200 in order to provide radiant heat to maintain a predetermined temperature of the infant patient.

The heater element 212 and the reflective dish 214 can be configured to project the generated radiant heat using any number of focal points. For example, the reflective dish 214 can be parabolic, elliptical, or any other suitable geometric shape to enable one or more focal points that project the radiant heat to the reflective dish 216 about the support platform 202. In some examples, the focal points can be the heater element 212 as well as any suitable intersection of directed radiant heat rays from the reflective dish 214 towards the reflective dish 216.

In some examples, radiant heat can be provided by the configurable heater 210 of the infant care station 200 to provide radiant warming or the configurable heater 210 can modulate, move, swivel, or the like to focus the radiant heat downwards toward a heat sink as in FIGS. 6-10.

In some examples, the infant care station 200 can operate in a warmer configuration or an incubator configuration. As discussed in greater detail below in relation to FIG. 6, the infant care station 200 can also include any number of fans 218 to circulate thermally conditioned air for an infant patient on the horizontal surface 202 using convective heating techniques with the reflective dish 214 modulated into a downward facing position.

In some examples, an infant care station 200 can include a housing channel 220 or space between the configurable heater 210 and an overhead reflective dish 216. The housing channel 220 can be any suitable shape or size to enable the focused radiant heat from a heater element 212 of the configurable heater 210 to be projected upward to the overhead reflective dish 216 using any number of focal points.

In some examples, the housing channel 220 can be lined or covered with any suitable material that may or may not be reflective. The reflective dish 214 can use focal points to direct or project radiant heat to the overhead reflective dish 216 so that the radiant heat travels in directed beams that may or may not interact with the housing channel 220. In some examples, the housing channel 220 can be located on an opposing wall 204 of the infant care station 200. In some examples, the housing channel 220 can also include any number of vents or open spaces that may be mechanically or electronically closed or opened to provide a predetermined amount of radiant heat from the heater element 212 of the configurable heater 210 to the overhead reflective dish 216. In some examples, the housing channel 220 can form a part of the wall of the infant care station 200 and may be used to conductively and convectively transfer a predetermined amount of heat to warm the infant compartment.

In some examples, the reflective dish 216 can be located over a mattress or support platform 202 of the infant care station 200, over a display panel 222 of an infant care station 200, behind a display panel 222 of the infant care station 200, or any other suitable location proximate to the support platform 202 or mattress.

The heater element 212, reflective dish 214 and the reflective dish 216 can be configured to provide radiant heat at a specific location on the support platform. For example, the reflective dish 214 and/or 216 can be parabolic, elliptical, or any other suitable geometric shape to enable projecting the radiant heat to an area of the support platform 202 based on the location and size of the infant. In another example, the reflective dish 214 and/or 216 can be parabolic, elliptical, or any other suitable geometric shape to enable projecting the radiant heat to a larger or smaller area; or closer or farther support platform 202 in relation to the configurable heater 210.

It is to be understood that the block diagram of FIG. 2A is not intended to indicate that the infant care station 200 is to include all of the components shown in FIG. 2A. Rather, the infant care station 200 can include fewer or additional components not illustrated in FIG. 2A (e.g., additional walls, porthole access points, display panels, or drawers, etc.). For example, the infant care station 200 can include any number of configurable heaters 210 that can provide, generate, or otherwise emit radiant heat toward the support platform or horizontal surfer 202 of the infant care station 200. In some examples, two or more configurable heaters 210 can be positioned proximate one another and can simultaneously modulate to provide convective heating for an incubator setting or radiant heating for an infant warmer setting.

In some examples, one or more configurable heaters 210 can be configured to accept or utilize multiple heater elements 212. For example, a configurable heater 210 may include two or more heater elements 212 that emit or generate radiant heat, light waves, or the like that warms air within the infant care station 200 by projecting radiant heat onto the reflective dish 214. In some examples, the heater elements 212 of the configurable heater 210 can be made of the same materials or different materials and the heater elements 212 may be configured to generate the same amount of radiant heat or different amounts of radiant heat.

In some examples, the heater element 212 and reflective dish 214 can be configured to be moved to provide heat in an upward direction, a downward direction, or any other suitable direction. In some examples, the heater elements 212 and reflective dish 214 can be positioned such that radiant heat or light waves are emitted to a heat sink 224 located at the base 210 of the infant care station 200. In some examples, the heater elements 212 can be configured to modulate to a first predetermined location that causes radiant heat to be emitted to a heat sink 224 located below 202 where the heat is convectively transferred using fans and the like to the infant compartment of the infant care station 200. In some examples, the heater element 212 and the reflective dish 214 can act as a heat source in which one or more fans can draw air over the heater element 212 and the reflective dish 214 to provide thermally conditioned air, so radiant heat may not be focused on a heat sink 224. In some examples, the heater elements 212 can also be configured to modulate to a second predetermined location that causes radiant heat or light waves to be emitted upward to an overhead reflective dish 216. In some configurations, the radiant heat can be emitted from the heater elements 212 at any suitable angle within the housing channel 220 to the reflective dish 214 to result in the radiant heat or light waves propagating or otherwise traveling in the expected direction.

FIG. 2B depicts an example implementation of the configurable heater of an infant care station. In some examples, the infant care station 200 can use any suitable geometrical shape, such as an ellipse, among others, to project radiant heat between the heater element 212, the reflective dish 214 of the configurable heater 210 and the overhead reflective dish 216. In the example of FIG. 2b, an elliptical design results in two focal points, the heater element 212 and an intersection of radiant heat rays at point 223. In some examples, any suitable number of focal points can be used to project, reflect, or otherwise provide radiant heat from the heater element 212 to the reflective dish 214 and the overhead reflective dish 216. In FIG. 2B, the heater element 212 and the intersection of radiant heat rays at point 223 can project radiant heat to the overhead reflective dish 216.

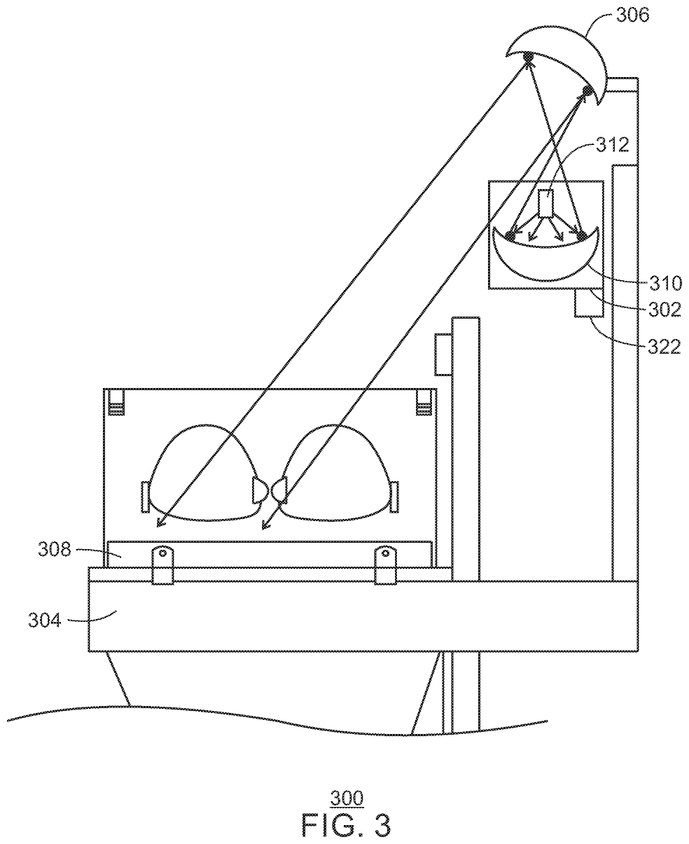

FIG. 3 is an example infant care station with a configurable heater. In some examples, the infant care station 300 can operate as an infant warmer, an incubator, or a combination thereof.

In some examples, the infant care station 300 can include a configurable heater 302 that can be placed at any suitable vertical location between a base 304 of the infant care station 300 and an overhead reflective dish 306. For example, the configurable heater 302 can be placed approximately midway between the base 304 and the overhead reflective dish 306, or any other suitable location. In some examples, the configurable heater 302 can also be located at any suitable location along a horizontal plane parallel to a support platform 308. For example, the configurable heater 302 can be placed towards an edge of the infant care station 302 rather than in the center of the infant care station 300.

The configurable heater 302 can be adjusted based on a vertical position and a horizontal position of the configurable heater 302 in the infant care station 300 so that any number of focal points are aligned to project radiant heat to the overhead reflective dish 306. For example, the configurable heater 302 can have two or more focal points projected from a reflective dish 310 and a heater element 312 of the configurable heater 302 to the overhead reflective dish 306 and a shape or design of the reflective dish 310 of the configurable heater 302 can be modified so that the two or more focal points are aligned to project radiant heat to the overhead reflective dish 306. In FIG. 3, two focal points such as the heater element 312 and an intersection of directed radiant heat 314 can project or reflect radiant heat from the heater element 312 to the overhead reflective dish 306. In some examples, a shape of the reflective dish 310 or the overhead reflective dish 306 can be modified to provide radiant heat using any suitable number of focal points.

It is to be understood that the block diagram of FIG. 3 is not intended to indicate that the infant care station 300 is to include all of the components shown in FIG. 3. Rather, the infant care station 300 can include fewer or additional components not illustrated in FIG. 3 (e.g., additional walls, porthole access points, display panels, or drawers, etc.). For example, a controller 322 coupled to the configurable heater 302 can also be included to adjust a power level of the heater element 312, a distance between the heater element 312 and the reflective dish 310, or a distance between the reflective dish 310 and the overhead reflective dish 306 based on a number of focal points to be used for providing radiant heat.

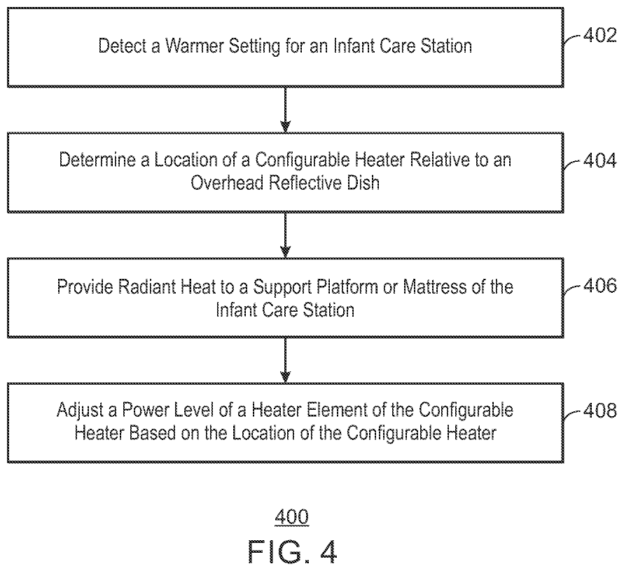

FIG. 4 is a process flow diagram for operating an infant care station with a configurable heater. In some examples, the method 400 can be implemented with any suitable device such as the infant care stations 200 and 300 of FIGS. 2A 2B, and 3, among others.

At block 402, the method 400 can include detecting a warmer setting for an infant care station. In some examples, the warmer setting can be detected from a setting in a user interface provided using a display panel. In some examples, the warmer setting can be detected in response to a canopy of an infant care station being raised or otherwise placed in an open microenvironment configuration. As discussed above, the warmer setting can allow ambient air from entering the microenvironment of the infant care station.

At block 404, the method 400 can include determining a location of a configurable heater relative to an overhead reflective dish. For example, the method 400 can include determining a distance from a reflective dish of a configurable heater to an overhead reflective dish. In some examples, the distance between the reflective dishes can be static or remain the same. In some examples, the distance between the reflective dishes can be dynamically modified as an infant care station changes operation from an incubator to a radiant warmer.

At block 406, the method 400 can include providing radiant heat to a support platform or mattress of the infant care station. In some examples, radiant heat is provided by facing the reflective dish coupled to the heater element in an upward direction and the second reflective dish in a downward direction to direct the radiant heat onto the support platform. In some examples, radiant heat is provided by facing the reflective dish coupled to the heater element in a downward direction. In some examples, the reflective dish coupled to the heater element reflects or otherwise projects the radiant heat to the base of the infant care station. In some examples, the method 400 can include modifying or changing an angle that radiant heat is projected from the configurable heater to the overhead reflective dish. In some examples, the shape and angle of the second reflective dish overhead can be changed to provide radiant heat to a specific location or area of the support platform.

In some examples, the heater can include any number of heater elements that provide radiant heat using an incandescent bulb, among others. In some examples, the heater elements can provide radiant heat using any suitable shaped incandescent bulb. The radiant heat can be reflected or projected into one or more directions from the heater element using any suitable reflective dish. The reflective dish can be parabolic, among other shapes or configurations.

The radiant heat waves reflected from the reflective dish coupled or proximate to the heater element can then be projected to the second reflective dish above the support platform, which can reflect the radiant heat onto the support platform of the infant care station. In some examples, the heater element can serve as a first focal point and an intersection of radiant heat rays reflected from the reflective dish of the heater can serve as a second focal point that projects or focuses radiant heat on an overhead reflective dish. The use of focal points can enable focusing radiant heat as opposed to configurations without focal points that do not focus radiant heat rays. For example, other implementations based on parabolas and the like may project radiant heat rays in a parallel manner that prevents focusing the radiant heat rays. In some examples, techniques herein can project radiant heat from a first reflective dish of a modulating heater to an overhead reflective dish using parallel radiant heat rays.

At block 408, the method 400 can also optionally include adjusting a power level of a heater element of the configurable heater based on the location of the configurable heater. In some examples, the power level can be based on the distance between the reflective dishes of the infant care station. For example, the power level can be increased as the distance between the top reflective dish and the mattress increases. In some examples, the power level can be adjusted based on the size and position of the neonate being warmed.

The process flow diagram of method 400 of FIG. 4 is not intended to indicate that all of the operations of blocks 402-408 of the method 400 are to be included in every example. Additionally, the process flow diagram of method 400 of FIG. 4 describes a possible order of executing operations. However, it is to be understood that the operations of the method 400 can be implemented in various orders or sequences. In addition, in some examples, the method 400 can also include fewer or additional operations.

FIG. 5 is a perspective view of an example infant care station operating as an incubator with a fixed heater. In the example of FIG. 5, an infant care station is depicted in which the infant care station is an incubator 500. The incubator 500 includes a horizontal surface 502 that is configured to support an infant patient (not depicted). It is to be understood that the incubator 500 may have the ability or control to modulate, move, rotate, or incline the horizontal surface 502; however, it will be understood that the horizontal surface 502 will generally remain horizontal such as to minimize movement of the infant patient within the incubator 500 due to gravity.

One or more walls 504 extend generally vertically from the horizontal surface 502. In the embodiment depicted in FIG. 5 of the incubator 500, four walls extend vertically from the horizontal surface 502 to define the rectangular shape of the incubator 500. However, it will be understood that in alternative examples, various numbers of walls 504 may be used to define the incubator into various geometric shapes which may include, but are not limited to, circles or hexagons. The incubator 500 can further include a canopy 506 that extends over the horizontal surface 502. In some examples, the canopy 506 can include multiple components or surfaces, or the canopy may be curved or domed in shape.

While the incubator of FIG. 5 is depicted with the horizontal surface 502, walls 504, and canopy 506 being connected, it will be understood that in alternative examples, including those described in greater detail herein, the horizontal surface 502, walls 504, and canopy 506 may be individual components that also may be moveable with respect to each other. For example, the canopy 506 can transition from a closed position to an open position in which any suitable portion of the canopy 506 is raised away from the walls 504 to allow the microenvironment 508 to be exposed to the surrounding environment of the incubator 500.

The horizontal surface 502, walls 504, and canopy 506 can define a microenvironment 508 contained within these structures. In some examples, the incubator 500 is configured such that the microenvironment 508 surrounds the infant patient (not depicted) such that the infant patient is only exposed to a controlled combination of environmental characteristics or conditions (temperature, humidity, O2 concentration, etc.) selected by a clinician to promote the health and wellbeing of the infant patient. In some examples, the walls 504 further include arm portholes 514 that permit a clinician access into the microenvironment 508.

In some examples, the incubator 500 includes a base 510 that houses a convective heater 512 (not depicted). The convective heater is operated such that air is drawn into the incubator 500, at which point the air may be filtered or sterilized in another manner, including the use of UV light before being passed by heating coils (not depicted) to heat the air to a target or set point temperature. The heated air is blown into the microenvironment 508 through vents (not depicted) which are arranged along the walls 504. As is also known, the air may be entrained with supplemental gasses such as oxygen or may have added humidity such as to control these conditions within the microenvironment 508. The convective heater is a dedicated heater for providing convective heating without the ability to modulate or provide radiant heating. In some examples, the incubator 500 may include a separate second heater (not depicted) that operates to provide radiant heat to an infant.

Examples of the incubator 500 further include a pedestal 516 connected to the base 510. The pedestal 516 includes mechanical components (not depicted), which may include, but are not limited to, servo motors, rack and pinion systems, or screw gear mechanisms that are operable by foot pedals 518 to raise or lower the base 510, effectively raising or lowering the position of the infant patient (not depicted) in relation to the clinician. The incubator 500 may be moveable by wheels or casters 520 connected to the pedestal 516.

The example of the incubator 500 depicted in FIG. 5 includes a graphical display 522 that is mounted to a wall, the base 510, or the canopy 506 of the incubator 500 at a position external to the microenvironment 508. The graphical display 522 is operated by a processor to present a graphical user interface (GUI) 524. In the example illustrated, the graphical display 522 is a touch-sensitive graphical display and the GUI 524 is configured to specifically respond to inputs made by a clinician received through the touch-sensitive graphical display. During normal operation, the touch-sensitive graphical display 522 and touch-sensitive configured GUI 524 are used to control various functions of the incubator 500. The GUI 524 presents a variety of information, such as the air temperature and alarm indications. In some examples, the alarm indications can provide a message indicating an access point is unsealed or open, a change in environment characteristics, or a warning that a heater is still operational after the canopy 506 has been closed, among others.

In some examples, the walls 504 of the incubator 500 can be opened or closed to enable a clinician to access a patient residing in the incubator 500. For example, the walls 504 can serve as doors that open and close to either remove a patient from the incubator 500 or to place a patient into the incubator 500. The walls 504 can include any number of access points, such as portholes 514 covered by porthole doors, which enable access to a patient residing in a microenvironment of the incubator 500.

FIG. 6 is an example of an infant care station using a configurable heater in a static position to provide convective heat in an incubator setting in accordance with one example. In some examples, the infant care station 600 can include a horizontal surface (also referred to herein as a bed) 602, walls 604, and canopy 606 being connected to form microenvironment 608. In some examples, the horizontal surface 602, walls 604, and canopy 606 may be individual components that also may be moveable with respect to each other. For example, the example configuration of FIG. 6 depicts a closed canopy 606 on the walls 604 to allow operation as an incubator which the microenvironment 608 is not exposed to the surrounding environment of the infant care station 600.

In some examples, the infant care station 600 includes a base 610 that supports the support platform or bed 602. The infant care station 600 can also include a configurable heater 612 proximate to the support platform 602. The configurable heater 612 can be configured to provide radiant heat to the support platform 602 in a uniform, desired, or expected manner to warm an infant patient. For example, the configurable heater 612 can be configured to provide radiant heat downward to a heat sink 614.

The heat sink 614, which has been heated using radiant heat from 612 can enable thermally conditioned air to be provided to the microenvironment 608 convectively using any suitable number of fans, ducts, channels, or the like that can distribute the thermally conditioned air to any number of areas along the bottom or perimeter of a mattress or support platform 602 of the infant care station 600. In some examples, the configurable heater 612 conductively couples to the heat sink 614 to conductively transfer heat to 614. Heat from 614 is convectively transferred to provide thermally conditioned air to maintain a predetermined temperature of the microenvironment 608.

In some examples, the configurable heater 612 of the infant care station 600 can include a heater element 616 and a reflective dish 618 configured to provide radiant heat for the infant care station 600. For example, the heater element 616 can project or transfer radiant heat using the reflective dish 618 to the heat sink 614.

The radiant heat can be provided by the infant care station 600 to the base 610 of the infant care station 600 as illustrated in FIG. 6 or the radiant heat can be provided upwards for a radiant heater setting described in relation to FIGS. 2A, 2B, and 3 described above. In some examples, the configurable heater 612 can generate, produce, or otherwise emit radiant heat that can be projected from heater element 616 onto an overhead reflective dish 619. In some examples, the configurable heater 612 can rotate the heater element, the reflective dish of the configurable heater 612, or a combination thereof in order to direct radiant heat to the heat sink 614 and the fans 620.

In some examples, for the incubator setting, the configurable heater 612 may not have rotational capability and could be fixed, focusing the heat waves onto the heat sink 614. The power level of the configurable heater 612 can be adjusted by any suitable control system for the different modes of operation. In some examples, the configurable heater 612 is configured to rotate to provide heat to the support platform using either a convective heating technique or a radiant heating technique.

In some examples, any number of fans 620 can be included in the infant care station 600 to circulate the thermally conditioned air within the microenvironment 608 of the infant care station 600. For example, any number of fans 620 can circulate the thermally conditioned air from within the microenvironment 608 through any number of openings (not depicted) in a wall, housing, or the like separating the microenvironment 608 from the configurable heater 612. In some examples, the thermally conditioned air can have an altered temperature using the radiant heat from the configurable heater 612, a modified humidity, or the like.

It is to be understood that the block diagram of FIG. 6 is not intended to indicate that the infant care station 600 is to include all of the components shown in FIG. 6. Rather, the infant care station 600 can include fewer or additional components not illustrated in FIG. 6 (e.g., additional walls, porthole access points, display panels, or drawers, etc.).

In some examples, the configurable heater 612 can be moved within the housing 630 of FIG. 6. The housing 630 can support or protect the configurable heater 612 as the canopy 606 raises and lowers to enable a radiant warmer setting or an incubator setting of the infant care station 600. In some examples, the configurable heater 612 can raise or lower as the canopy 606 transitions from an enclosed incubator to a raised warmer in some configurations. Accordingly, the configurable heater 612 may not be located in a static position or location in relation to the support platform 604 of the infant care station 600. Instead, the configurable heater 612 can dynamically raise and lower in relation to the support platform 604 of the infant care station 600.

In some examples, the configurable heater 612 can rotate any suitable number of degrees around a horizontal or vertical axis to provide radiant heat upward as a radiant heater or downward to a heat sink 614 to provide convective heating to the support platform 602 of the infant care station 600. In some examples, the configurable heater 612 is designed to operate with a second reflective dish 619 located above the support platform 604. For example, the configurable heater 612 can rotate upward to provide radiant heat to a second reflective dish 619 located above the support platform 604. In some examples, the configurable heater 612 rotates to a predetermined angle so that the configurable heater 612 directly provides warm air, light waves, or radiant heat to the support platform 604 without a second reflective dish 619. As the canopy 606 transitions to an incubator setting and is lowered, the configurable heater 612 can rotate to any suitable location, rotation, or the like to provide warm air, light waves, or radiant heat to a heat sink 614 that distributes thermally conditioned air using convective heating techniques to the support platform 604.

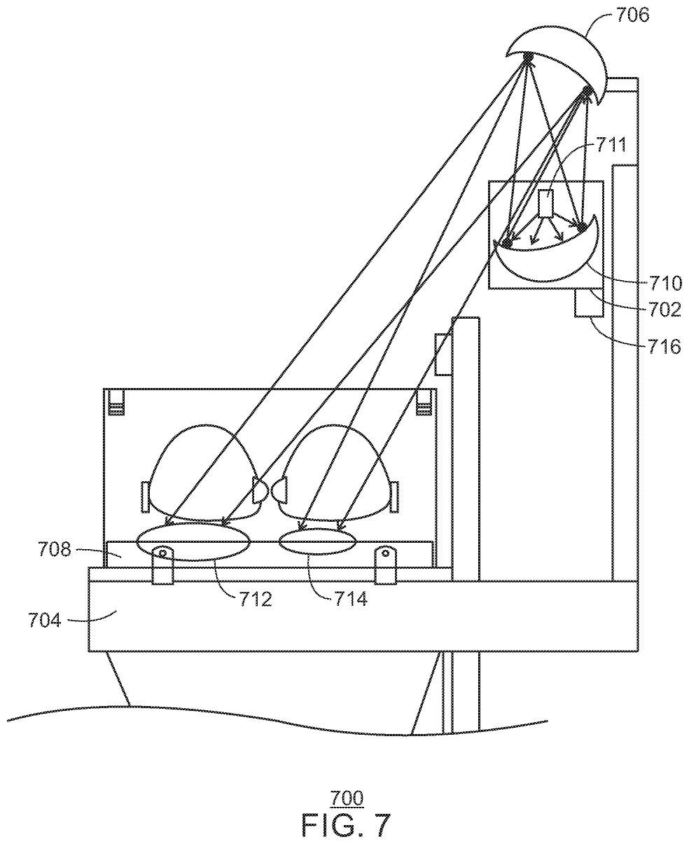

FIG. 7 depicts an example of an infant care station configured to operate as a radiant warmer with a configurable heater. In some examples, the infant care station 700 can include a configurable heater 702 that can be placed at any suitable vertical location between a base 704 of the infant care station 700 and an overhead reflective dish 706. For example, the configurable heater 702 can be placed approximately midway between the base 704 and the overhead reflective dish 706, or any other suitable location.

As discussed above, the configurable heater 702 can be adjusted based on a vertical position and a horizontal position of the configurable heater 702 in the infant care station 700 to enable projecting, reflecting, or transferring radiant heat from the configurable heater 702 to a support platform 708 using the overhead reflective dish 706.

In some examples, the reflective dish 710 of the configurable heater 702 and/or the reflective dish 706 can be modified to change a surface shape so that the radiant heat can be projected along different paths to different locations on the support platform, or the like. Modifying or changing the surface shape of the overhead reflective dish 706 can result in radiant heat being transferred to different portions or locations of the support platform 708. Modifying or changing the surface shape of the reflective dish 710 can result in radiant heat being transferred to the overhead reflective dish 706 and to different portions or locations of the support platform 708. For example, a first surface shape of the reflective dish 710 can result in uniform radiant heat being projected or distributed from the reflective dish 706 to a first region 712 of the support platform 708 using the overhead reflective dish 706. In some examples, a second surface shape of the reflective dish 710 can result in uniform radiant heat being projected or distributed from the reflective dish 706 to a second region 714 of the support platform 708 using the overhead reflective dish 706. In some examples, the regions 712 and 714 can correspond to a location of an infant on the support platform 708.

It is to be understood that the block diagram of FIG. 7 is not intended to indicate that the infant care station 700 is to include all of the components shown in FIG. 7. Rather, the infant care station 700 can include fewer or additional components not illustrated in FIG. 7 (e.g., additional walls, porthole access points, display panels, or drawers, etc.). In some examples, a controller 716 can modify a shape of the reflective dish 710 by electronically or mechanically changing the shape of the reflective dish 710 using any suitable number of components.

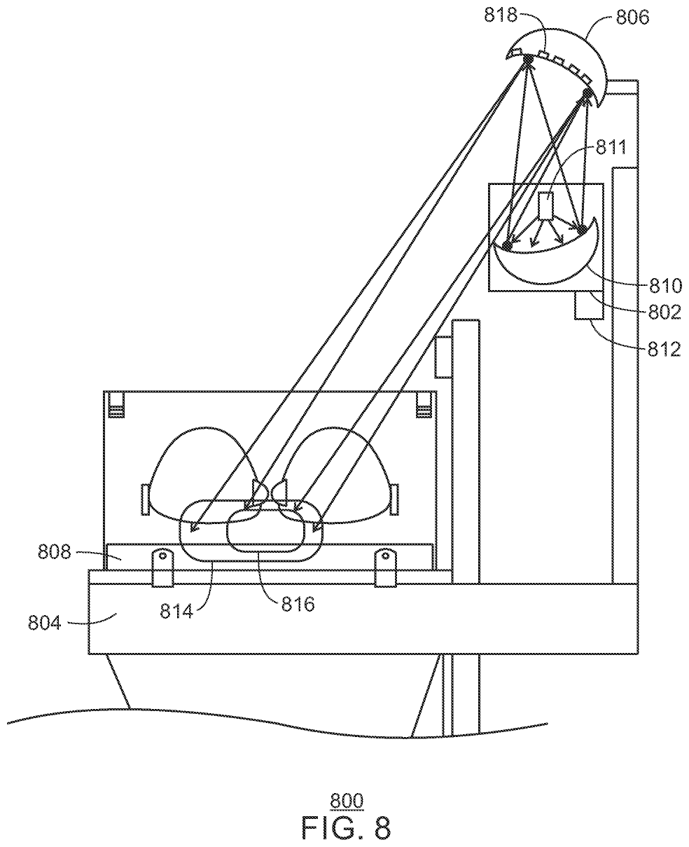

FIG. 8 depicts an example of an infant care station configured to operate as a radiant warmer with a configurable heater. In some examples, the infant care station 800 can include a configurable heater 802 that can be placed at any suitable vertical location between a base 804 of the infant care station 800 and an overhead reflective dish 806. For example, the configurable heater 802 can be placed approximately midway between the base 804 and the overhead reflective dish 806, or any other suitable location.

As discussed above, the configurable heater 802 can be adjusted based on a vertical position and a horizontal position of the configurable heater 802 in the infant care station 800 to enable projecting, reflecting, or transferring radiant heat from the configurable heater 802 to a support platform 808 using the overhead reflective dish 806.

In some examples, the reflective dish 810 of the configurable heater 802 and/or the reflective dish 806 can be modified to change a surface shape so that the radiant heat can be projected along different paths to different sized regions on the support platform, or the like. Modifying or changing the surface shape of the overhead reflective dish 806 can result in radiant heat being transferred to different portions or locations of the support platform 808. Modifying or changing the surface shape of the reflective dish 810 can result in radiant heat being transferred to the overhead reflective dish 806 and to different portions or locations of the support platform 808. In some examples, a controller 812 can modify a shape of the reflective dish 810 and/or 806 by electronically or mechanically changing the shape of the reflective dish 810 and/or 806 using any suitable number of components.

For example, a first surface shape of the reflective dish 810 can result in uniform radiant heat being projected or distributed from the reflective dish 810 to a first region 814 of the support platform 808 using the overhead reflective dish 806. The first region 814 can be determined, identified, or otherwise calculated based on a size of an infant located on the support platform 808. In some examples, a second surface shape of the reflective dish 810 can result in uniform radiant heat being projected or distributed from the reflective dish 810 to a second region 816 of the support platform 808 using the overhead reflective dish 806. In some examples, the second region 816 can correspond to a different sized infant on the support platform 808. In some examples, the infant care station 800 can continuously track an infant's position on the support platform and adjust one or both of the reflective dish surfaces 806 and 810 to focus the radiant heat wherever the infant moves on the support platform.

It is to be understood that the block diagram of FIG. 8 is not intended to indicate that the infant care station 800 is to include all of the components shown in FIG. 8. Rather, the infant care station 800 can include fewer or additional components not illustrated in FIG. 8 (e.g., additional walls, porthole access points, display panels, or drawers, etc.).

In some examples, the reflective dish 806 can be modified to have a different surface shape by changing individually, a direction of any number of mirrors 818 or reflective surfaces of the reflective dish 806. The surface shape of the reflective dish 806 in combination with the surface shape of the reflective dish 810 can result in radiant heat being transmitted, projected, or otherwise provided to an infant on the support platform 808. For example, changing an angle or orientation of mirrors 818 of the reflective dish 806, reflective dish 810, or a combination thereof can result in radiant heat being projected onto a different location of the support platform 808, a different sized region or area of the support platform 808, or the like. In some examples, changing an angle or orientation of mirrors 818 of the reflective dish 806, reflective dish 810, or a combination thereof, can be used to provide a heat distribution (regions with more heat and regions with less heat), if so desired.

FIG. 9 is a process flow diagram for operating a configurable overhead reflective dish of an infant care station. In some examples, the method 900 can be implemented with any suitable device such as the infant care stations 600, 700, or 800, FIG. 6, 7, or 8.

At block 902, the method 900 can include detecting a reconfiguration of the infant care station. In some examples, the reconfiguration can include a modification to the heater element of the configurable heater, wherein the modification can include installing a new heater element, adding an additional heater element, removing a heater element, or the like. The reconfiguration can also include modifying a vertical location of the configurable heater, a horizontal location of the configurable heater, or a combination thereof.

The reconfiguration can also include changing an operation mode of the infant care station from an incubator setting to a radiant warmer setting. In some examples, the incubator setting can operate with a closed canopy and a radiant warmer setting can operate with an open canopy. In some examples, a configuration can be detected based on whether a canopy is open or closed, a setting from a display panel, or the like. In some examples, the reconfiguration can include transitioning from an incubator setting to a warmer setting or from a warmer setting to an incubator setting. In some examples, a reconfiguration can include any modifying, adjusting, or otherwise changing a component of the infant care station, a location of a component of the infant care station, a setting of a component of the infant care station, or the like.

At block 904, the method 900 can include modifying, altering, or otherwise changing an overhead reflective dish in response to the reconfiguration of the infant care station. As illustrated in FIGS. 6, 7, and 8, a shape of the overhead reflective dish can be modified to focus radiant heat on any suitable area of a support platform, bed, or mattress of an infant care station. For example, the overhead reflective dish can be repositioned, a shape of a surface of the overhead reflective dish can be mechanically or electronically modified, or the like. In some examples, the overhead reflective dish can include any number of smaller mirrors, or any other surface, which can be repositioned or angle changed in relation to one another to focus radiant heat from a configurable heater to a support platform of an infant care station.

At block 906, the method 900 can include providing radiant heat to a support platform using a configurable heater and a modified overhead reflective dish. In some examples, the radiant heat can be provided uniformly by the modified overhead reflective dish to a larger or smaller portion of a support platform based on a size of an infant, an area of a support platform based on a location of an infant, or the like.

The process flow diagram of method 900 of FIG. 9 is not intended to indicate that all of the operations of blocks 902-906 of the method 900 are to be included in every example. Additionally, the process flow diagram of method 900 of FIG. 9 describes a possible order of executing operations. However, it is to be understood that the operations of the method 900 can be implemented in various orders or sequences. In addition, in some examples, the method 900 can also include fewer or additional operations.

In some examples, the first reflective dish is configured to rotate 180 degrees from a downward facing position providing convective heated air to an upward facing position providing radiant heat to a second reflective dish that distributes the radiant heat to the support platform using a radiant warming technique. In some examples, the heater element and the reflective dish are coupled to a canopy of the infant care station, and wherein the heater element and the reflective dish are configured to simultaneously rotate from a first position providing convective heat as an incubator when the canopy is closed to a second position providing radiant heat as a warmer when the canopy is open.

FIG. 10 is a block diagram of an example of a computing device that can operate a configurable heater in an infant care station. The computing device 1000 may be, for example, an infant care station, a laptop computer, a desktop computer, a tablet computer, or a mobile phone, among others. The computing device 1000 may include a processor 1002 that is adapted to execute stored instructions, as well as a memory device 1004 that stores instructions that are executable by the processor 1002. The processor 1002 can be a single core processor, a multi-core processor, a computing cluster, or any number of other configurations. The memory device 1004 can include random access memory, read only memory, flash memory, or any other suitable memory systems. The instructions that are executed by the processor 1002 may be used to implement a method that can operate a configurable heater in an infant care station, as described in greater detail above in relation to FIGS. 2-4 and 6-9.

The processor 1002 may also be linked through the system interconnect 1006 (e.g., PCI, PCI-Express, NuBus, etc.) to a display interface 1008 adapted to connect the computing device 1000 to a display device 1010. The display device 1010 may include a display screen that is a built-in component of the computing device 1000. The display device 1010 may also include a computer monitor, television, or projector, among others, which is externally connected to the computing device 1000. The display device 1010 can include light emitting diodes (LEDs), and micro-LEDs, Organic light emitting diode OLED displays, among others.

The processor 1002 may be connected through a system interconnect 1006 to an input/output (I/O) device interface 1012 adapted to connect the computing device 1000 to one or more I/O devices 1014 The I/O devices 1014 may include, for example, a keyboard and a pointing device, wherein the pointing device may include a touchpad or a touchscreen, among others. The I/O devices 1014 may be built-in components of the computing device 1000 or may be devices that are externally connected to the computing device 1000.

In some embodiments, the processor 1002 may also be linked through the system interconnect 1006 to a storage device 1016 that can include a hard drive, an optical drive, a USB flash drive, an array of drives, or any combinations thereof. In some embodiments, the storage device 1016 can include any suitable applications. In some embodiments, the storage device 1016 can include a heater manager 1018. In some embodiments, the heater manager 1018 can detect a warmer setting for an infant care station and determine a location of a configurable heater relative to an overhead reflective dish. The heater manager 1018 can also adjust a power level of a heater element of the configurable heater based on the location of the configurable heater and provide radiant heat to a support platform or mattress of the infant care station.

In some examples, the heater manager 1018 can also detect a reconfiguration of the infant care station and modify, alter, or otherwise change an overhead reflective dish in response to the reconfiguration of the infant care station. The heater manager 1018 can also provide radiant heat to a support platform using a configurable heater and a modified overhead reflective dish.

In some examples, a network interface controller (also referred to herein as a NIC) 1020 may be adapted to connect the computing device 1000 through the system interconnect 1006 to a network 1022. The network 1022 may be a cellular network, a radio network, a wide area network (WAN), a local area network (LAN), or the Internet, among others. The network 1022 can enable data, such as alerts, among other data, to be transmitted from the computing device 1000 to remote computing devices, remote display devices, and the like. In some examples, the heater manager 1018 can transmit, using the NIC 1020 and the network 1022, an alert to any suitable external device such as a mobile device, a computing device, or a device in a hospital setting, among others.

It is to be understood that the block diagram of FIG. 10 is not intended to indicate that the computing device 1000 is to include all of the components shown in FIG. 10. Rather, the computing device 1000 can include fewer or additional components not illustrated in FIG. 10 (e.g., additional memory components, embedded controllers, additional modules, additional network interfaces, etc.). Furthermore, any of the functionalities of the heater manager 1018 may be partially, or entirely, implemented in hardware and/or in the processor 1002. For example, the functionality may be implemented with an application specific integrated circuit, logic implemented in an embedded controller, or in logic implemented in the processor 1002, among others. In some embodiments, the functionalities of the heater manager 1018 can be implemented with logic, wherein the logic, as referred to herein, can include any suitable hardware (e.g., a processor, among others), software (e.g., an application, among others), firmware, or any suitable combination of hardware, software, and firmware.

FIG. 11 is an example of a non-transitory machine-readable medium for heating an infant care station with a configurable heater, in accordance with examples. The non-transitory, machine-readable medium 1100 can implement the functionalities of the heater manager 1018 of FIG. 10, among others. For example, a processor 1102 can access the non-transitory, machine-readable media 1100.

In some examples, the non-transitory, machine-readable medium 1100 can include instructions to execute a heater manager 1018. For example, the non-transitory, machine-readable medium 1100 can include instructions for the heater manager 1018 that cause the processor 1102 to can detect a warmer setting for an infant care station and determine a location of a configurable heater relative to an overhead reflective dish. The non-transitory, machine-readable medium 1100 can also include instructions for the heater manager 1018 that cause the processor 1102 to adjust a power level of a heater element of the configurable heater based on the location of the configurable heater and provide radiant heat to a support platform or mattress of the infant care station.

In some examples, the non-transitory, machine-readable medium 1100 can include instructions for the heater manager 1118 that cause the processor 1102 to detect a reconfiguration of the infant care station and modify, alter, or otherwise change an overhead reflective dish in response to the reconfiguration of the infant care station. In some examples, the non-transitory, machine-readable medium 1100 can include instructions for the heater manager 1018 that cause the processor 1102 to provide radiant heat to a support platform using a configurable heater and a modified overhead reflective dish.

In some examples, the non-transitory, machine-readable medium 1100 can include instructions to implement any combination of the techniques of the heater manager 1018 described above.

### EXAMPLES

In some examples, an infant care station can include a heater element to generate radiant heat, a first reflective dish, and a second reflective dish positioned higher than a support platform of the infant care station, wherein the first reflective dish and the second reflective dish transfer the radiant heat to the support platform, the first reflective dish to focus and project the radiant heat onto the second reflective dish.

Alternatively, or in addition, the heater element is located at a static position proximate to the support platform. Alternatively, or in addition, the heater element and first reflective dish are configured to dynamically reposition to focus the radiant heat on a heat sink proximate to the support platform to provide convective heating. Alternatively, or in addition, one or more fans circulate the thermally conditioned air to provide convective heating within the microenvironment. Alternatively, or in addition, a housing provides an enclosure in the infant care station for transferring the radiant heat from the heater element and the first reflective dish to the second reflective dish. Alternatively, or in addition, the housing comprises non-reflective material or reflective material. Alternatively, or in addition, the heater element and the first reflective dish are configured to rotate a predetermined number of degrees from a downward facing position providing the radiant heat to a heatsink to an upward facing position providing the radiant heat to a second reflective dish that distributes the radiant heat to the support platform.

Alternatively, or in addition, the first reflective dish is to focus and project the radiant heat on the second reflective dish using two or more focal points based on an elliptical configuration in which an intersection of the radiant heat is located between the first reflective dish and the second reflective dish in a housing of the infant care station. Alternatively, or in addition, the second reflective dish provides a uniform distribution of the radiant heat to the support platform. Alternatively, or in addition, the heater element and/or the first reflective dish are configured to rotate along a horizontal axis. Alternatively, or in addition, a surface shape of the first and/or second reflective dish is adjustable, wherein an adjustment to the surface shape modifies a distribution of the radiant heat to the support platform. Alternatively, or in addition, a power level of the heater element is adjustable, the power level to be adjusted as the heater and first reflective dish move from a first position to a second position, the second position comprising providing the radiant heat to a heat sink. Alternatively, or in addition, a sensing mechanism detects or tracks a location of an infant on the support platform, and the surface shape of the first and/or second reflective dish is modified based on the location of the infant to provide the radiant heat to the location of the infant, wherein power consumption for the heater element is reduced. Alternatively, or in addition, the second reflective dish comprises a plurality of small reflectors, wherein a direction of the plurality of the small reflectors is modified to modify a distribution of the radiant heat to the support platform.

In some examples, a method for operating an infant care station can include detecting a warmer setting for the infant care station, determining a location of a configurable heater relative to an overhead reflective dish, and adjusting a power level of a heater element of the configurable heater based on the location of the configurable heater, the power level to control an amount of radiant heat projected from the configurable heater to the overhead reflective dish. The method can also include providing radiant heat to a support platform of the infant care station.

Alternatively, or in addition, the power level is increased as a distance between the overhead reflective dish and the location of the support platform heater increases. Alternatively, or in addition, the power level is adjusted based on an area of the support platform to receive the radiant heat.

In some examples, non-transitory computer-readable medium for operating an infant care station can include a plurality of instructions that, in response to execution by a process, cause the processor to detect a reconfiguration of the infant care station, modify an overhead reflective dish in response to the reconfiguration of the infant care station, and provide radiant heat to a support platform using a configurable heater and a modified overhead reflective dish.

Alternatively, or in addition, the modifying the overhead reflective dish comprises modifying a surface shape of the overhead reflective dish to provide the radiant heat to a portion of the support platform based on a size of an infant. Alternatively, or in addition, the modifying the overhead reflective dish comprises modifying a surface shape of the overhead reflective dish to provide the radiant heat to a portion of the support platform based on an area of a support platform based on a location of an infant.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

Embodiments of the present disclosure shown in the drawings and described above are example embodiments only and are not intended to limit the scope of the appended claims, including any equivalents as included within the scope of the claims. Various modifications are possible and will be readily apparent to the skilled person in the art. It is intended that any combination of non-mutually exclusive features described herein are within the scope of the present invention. That is, features of the described embodiments can be combined with any appropriate aspect described above and optional features of any one aspect can be combined with any other appropriate aspect. Similarly, features set forth in dependent claims can be combined with non-mutually exclusive features of other dependent claims, particularly where the dependent claims depend on the same independent claim. Single claim dependencies may have been used as practice in some jurisdictions require them, but this should not be taken to mean that the features in the dependent claims are mutually exclusive.

What is claimed is:

1. An infant care station comprising:
a heater element to generate radiant heat;
a first reflective dish; and
a second reflective dish positioned higher than a support platform of the infant care station, wherein the first reflective dish and the second reflective dish transfer the radiant heat to the support platform, the first reflective dish to focus and project the radiant heat onto the second reflective dish.

2. The infant care station of claim 1, wherein the heater element is located at a static position proximate to the support platform.

3. The infant care station of claim 1, wherein the heater element and first reflective dish are configured to dynamically reposition to focus the radiant heat on a heat sink proximate to the support platform to provide convective heating.

4. The infant care station of claim 3, wherein one or more fans circulate thermally conditioned air to provide convective heating within a microenvironment.

5. The infant care station of claim 1, wherein a housing provides an enclosure in the infant care station for transferring the radiant heat from the heater element and the first reflective dish to the second reflective dish.

6. The infant care station of claim 5, wherein the housing comprises non-reflective material or reflective material.

7. The infant care station of claim 1, wherein the heater element and the first reflective dish are configured to rotate a predetermined number of degrees from a downward facing position providing the radiant heat to a heatsink to an upward facing position providing the radiant heat to the second reflective dish that distributes the radiant heat to the support platform.

8. The infant care station of claim 1, wherein the first reflective dish is to focus and project the radiant heat on the second reflective dish using two or more focal points based on an elliptical configuration in which an intersection of the radiant heat is located between the first reflective dish and the second reflective dish in a housing of the infant care station.

9. The infant care station of claim 1, wherein the second reflective dish provides a heat distribution of the radiant heat to the support platform.

10. The infant care station of claim 1, wherein the heater element and/or the first reflective dish are configured to rotate along a horizontal axis.

11. The infant care station of claim 1, wherein a surface shape of the first and/or second reflective dish is adjustable, wherein an adjustment to the surface shape modifies a distribution of the radiant heat to the support platform.

12. The infant care station of claim 11, wherein a power level of the heater element is adjustable, the power level to be adjusted as the heater element and the first reflective dish move from a first position to a second position, the second position comprising providing the radiant heat to a heat sink.

13. The infant care station of claim 11, wherein a sensing mechanism detects a location of an infant on the support platform, and the surface shape of the first and/or second reflective dish is modified based on the location of the infant to provide the radiant heat to the location of the infant, wherein power consumption for the heater element is reduced.

14. The infant care station of claim 11, wherein the second reflective dish comprises a plurality of small reflectors, wherein a direction of the plurality of the small reflectors is modified to modify a distribution of the radiant heat to the support platform.

15. A method for operating an infant care station comprising:
detecting a warmer setting for the infant care station;
determining a location of a configurable heater relative to an overhead reflective dish;
adjusting a power level of a heater element of the configurable heater based on the location of the configurable heater, the power level to control an amount of radiant heat projected from the configurable heater to the overhead reflective dish; and
providing radiant heat to a support platform of the infant care station.

16. The method of claim 15, wherein the power level is increased as a distance between the overhead reflective dish and the location of the support platform increases.

17. The method of claim 15, wherein the power level is adjusted based on an area of the support platform to receive the radiant heat.

18. A non-transitory computer-readable medium for operating an infant care station comprising a plurality of instructions that, in response to execution by a processor, cause the processor to:
detect a reconfiguration of the infant care station;
modify an overhead reflective dish in response to the reconfiguration of the infant care station; and
provide radiant heat to a support platform using a configurable heater and a modified overhead reflective dish.

19. The non-transitory computer-readable medium of claim 18, wherein the modifying the overhead reflective dish comprises modifying a surface shape of the overhead reflective dish to provide the radiant heat to a portion of the support platform based on a size of an infant.

20. The non-transitory computer-readable medium of claim 18, wherein the modifying the overhead reflective dish comprises modifying a surface shape of the overhead reflective dish to provide the radiant heat to a portion of the support platform based on an area of the support platform based on a location of an infant.
